(19) United States
(12) Patent Application Publication
(10) Pub. No.: US 2023/0033095 A1
(43) Pub. Date: Feb. 2, 2023

(54) THREE-DIMENSIONAL PRINTING WITH FLAME RETARDANTS

(71) Applicant: HEWLETT-PACKARD DEVELOPMENT COMPANY, L.P., SPRING, TX (US)

(72) Inventors: SHANNON RUEBEN WOODRUFF, SAN DIEGO, CA (US); EMRE HIRO DISCEKICI, SAN DIEGO, CA (US); GRACIELA EMMA NEGRI JIMENEZ, SAN DIEGO, CA (US)

(21) Appl. No.: 17/758,161

(22) PCT Filed: Jan. 29, 2020
(86) PCT No.: PCT/US2020/015596

§ 371 Date: Jun. 29, 2022

(51) Int. Cl. C09D 11/38; C09D 11/037; C09D 11/033; C09D 11/102; C09D 11/324; B33Y 10/00; B33Y 30/00; B33Y 70/00; B29C 64/165

(52) U.S. Cl. CPC C09D 11/38; B29C 64/165; B33Y 10/00; B33Y 30/00; B33Y 70/00; C09D 11/033; C09D 11/037; C09D 11/102; C09D 11/324; B29K 2077/00; B29K 2995/0016

(57) ABSTRACT

A three-dimensional printing kit can include a polymeric build material and a fusing agent. The polymeric build material can include polymer particles having a D50 particle size from about 2 µm to about 150 µm. The fusing agent can include an aqueous liquid vehicle including water and an organic co-solvent, a radiation absorber to generate heat from absorbed electromagnetic radiation, and from about 5 wt% to about 20 wt% flame retardant including dicyandiamide.

### BACKGROUND

Three-dimensional (3D) printing may be an additive printing process used to make three-dimensional solid parts from a digital model. Three-dimensional printing is often used in rapid product prototyping, mold generation, mold master generation, and short run manufacturing. Some three-dimensional printing techniques can be considered additive processes because they involve the application of successive layers of material. This can be unlike other machining processes, which often rely upon the removal of material to create the final part.

### BRIEF DESCRIPTION OF THE DRAWINGS

FIG. 1A and FIG. 1B collectively show a schematic representation of an example three-dimensional printing kit in accordance with the present disclosure;

FIG. 2 is a flow diagram illustrating an example method of printing a three-dimensional object in accordance with the present disclosure; and

FIG. 3 is a schematic illustration of an example three-dimensional printing system in accordance with the present disclosure.

### DETAILED DESCRIPTION

Three-dimensional printing can be an additive process involving the application of successive layers of a polymeric build material with a fusing agent printed thereon to bind the successive layers of the polymeric build material together. More specifically, a fusing agent including a radiation absorber can be selectively applied to a layer of a polymeric build material on a support bed, e.g., a build platform supporting polymeric build material, to pattern a selected region of a layer of the polymeric build material. The layer of the polymeric build material can be exposed to electromagnetic radiation, and due to the presence of the radiation absorber on the printed portions, absorbed light energy at those portions of the layer having the fusing agent printed thereon can be converted to thermal energy, causing that portion to melt or coalesce, while other portions of the polymeric build material do reach temperatures suitable to melt or coalesce. This can then repeated on a layer-by-layer basis until the three-dimensional object is formed.

In accordance with this, a three-dimensional printing kit (or "kit") can include a polymeric build material and a fusing agent. The polymeric build material can include polymer particles having a D50 particle size from about 2 µm to about 150 µm. The fusing agent can include an aqueous liquid vehicle including water and an organic co-solvent, a radiation absorber to generate heat from absorbed electromagnetic radiation, and from about 5 wt% to about 20 wt% flame retardant including dicyandiamide. In one example, the flame retardant can further include dicyanamide, cyanamide, melamine, guanylmelamine, polyguanylmelamine, guanidine, guanidine carbonate, guanylurea, or a combination thereof. In another example, the flame retardant can be present in the fusing agent at from about 8 wt% to about 16 wt%. In yet another example, the radiation absorber can include carbon black, a metal dithiolene complex, a near-infrared absorbing dye, a near-infrared absorbing pigment, metal nanoparticles, a conjugated polymer, or a combination thereof. In a further example, the radiation absorber can be present in the fusing agent at from about 0.1 wt% to about 10 wt%. In one example, the aqueous liquid vehicle can further include from about 0.01 wt% to about 2 wt% surfactant. In another example, the polymeric build material can include polyamide, polyethylene, polyethylene terephthalate (PET), polystyrene, polyacrylate, polyacetal, polypropylene, polycarbonate, polyester, acrylonitrile butadiene styrene, thermoplastic polyurethane, engineering plastic, polyetheretherketone (PEEK), polymer blends thereof, amorphous polymers thereof, core-shell polymers thereof, and copolymers thereof. In yet another example, the kit can further include a detailing agent. The detailing agent can include a detailing compound to reduce a temperature of the polymeric build material onto which the detailing agent is applied.

In another example of the present disclosure, a method of printing a three-dimensional object (or "method") can include iteratively applying individual polymeric build material layers of a polymeric build material including polymer particles having a D50 particle size from about 2 µm to about 150 µm, and based on a 3D object model, iteratively and selectively dispensing a fusing agent onto individual polymeric build material layers. The fusing agent can include an aqueous liquid vehicle including water and an organic co-solvent, a radiation absorber to generate heat from absorbed electromagnetic radiation, and from about 5 wt% to about 20 wt% flame retardant including dicyandiamide. The method can further include iteratively exposing the individual polymeric build material layers with the fusing agent dispensed therewith to electromagnetic radiation to selectively fuse polymer particles of the polymeric build material in contact with the radiation absorber and to form a fused three-dimensional object. In one more specific example, the flame retardant can further include dicyanamide, cyanamide, melamine, guanylmelamine, a polyguanylmelamine, guanidine, guanidine carbonate, guanylurea, or a combination thereof. In another example, the radiation absorber can include carbon black. In one example, the flame retardant can be applied to the individual polymeric build material layers at a flame retardant to polymeric build material weight ratio from about 1:20 to about 1: 100. In yet another example, the method can further include iteratively and selectively dispensing a detailing agent onto individual polymeric build material layers laterally at a border between a first area where the individual polymeric build material layer is contacted by the fusing agent and a second area where the individual polymeric build material layer is not contacted by the fusing agent.

In a further example, a three-dimensional printing system (or "system") can include a polymeric build material including polymer particles having a D50 particle size from about 2 µm to about 150 µm and a fluid applicator fluidly coupled or coupleable to a fusing agent. The fluid applicator can be directable to iteratively apply the fusing agent to layers of the polymeric build material. The fusing agent can include an aqueous liquid vehicle including water and an organic co-solvent, a radiation absorber to generate heat from absorbed electromagnetic radiation, and from about 5 wt% to about 20 wt% flame retardant including dicyandiamide. In one example, the system can further include an electromagnetic radiation source positioned to provide electromagnetic radiation to the layers of the polymeric build material having the fusing agent applied thereto.

When discussing the three-dimensional printing kit, method of printing a three-dimensional object, and/or the three-dimensional printing system herein, these discussions can be considered applicable to one another whether or not they are explicitly discussed in the context of that example. Thus, for example, when discussing a polymeric build material related to a three-dimensional printing kit, such disclosure is also relevant to and directly supported in the context of the method of printing a three-dimensional object, the three-dimensional printing system, and vice versa.

Terms used herein will have the ordinary meaning in their technical field unless specified otherwise. In some instances, there are terms defined more specifically throughout the specification or included at the end of the present specification, and thus, these terms can have a meaning as described herein.

### Three-Dimensional Printing Kits

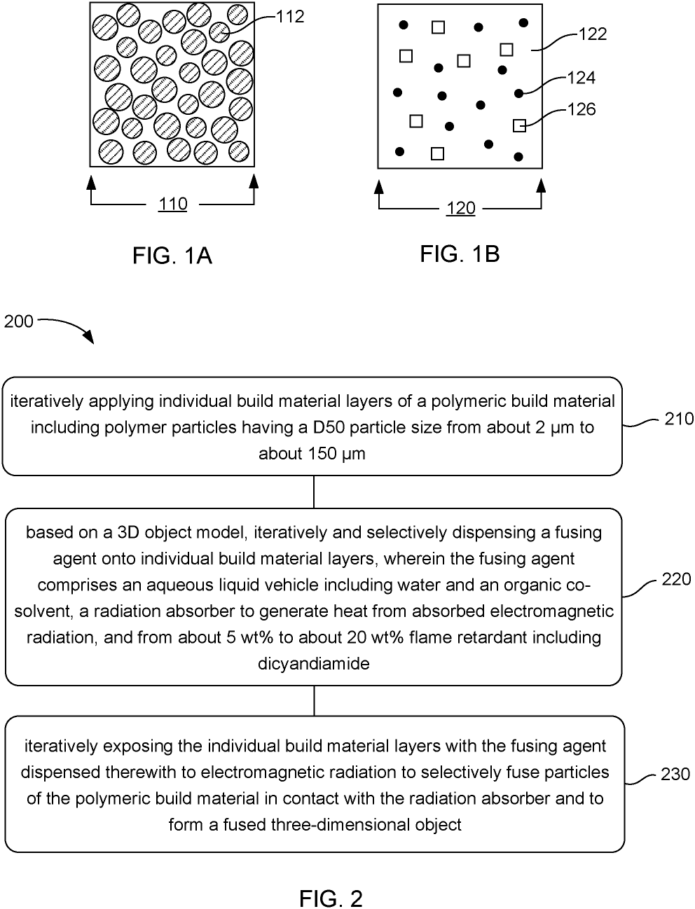

A three-dimensional printing kit is shown collectively by way of example in FIG. 1A and FIG. 1B. The three-dimensional printing kit can include, for example, a polymeric build material 110, shown in FIG. 1A, and a fusing agent 120, shown in FIG. 1B. The polymeric build material can include polymer particles 112 having a D50 particle size from about 2 µm to about 150 µm. The fusing agent can include an aqueous liquid vehicle 122 including water and an organic co-solvent, a radiation absorber 124 to generate heat from absorbed electromagnetic radiation, and from about 5 wt% to about 20 wt% flame retardant including dicyandiamide 126.

In some examples, the three-dimensional printing kit can further include other fluids, such as coloring agents, detailing agents, or the like. A detailing agent, for example, can include a detailing compound, which can be a compound that can reduce the temperature of the polymeric build material when applied thereto. In some examples, the detailing agent can be applied around edges of the application area of the fusing agent. This can prevent caking around the edges due to heat from the area where the fusing agent was applied. The detailing agent can also be applied in the same area where the fusing agent was applied in order to control the temperature and prevent excessively high temperatures when the polymeric build material is fused.

The polymeric build material may be packaged or co-packaged with the fusing agent, coloring agent, detailing agent, or the like in separate containers, and/or can be combined with the fusing agent at the time of printing, e.g., loaded together in a three-dimensional printing system.

### Methods of Printing Three-dimensional Objects

A flow diagram of an example method 200 of three-dimensional (3D) printing is shown in FIG. 2. The method can include iteratively 210 applying individual polymeric build material layers of a of a polymeric build material including polymer particles having a D50 particle size from about 2 µm to about 150 µm; based on a 3D object model, iteratively and selectively 220 dispensing a fusing agent onto individual polymeric build material layers, where the fusing agent can include an aqueous liquid vehicle including water and an organic co-solvent, a radiation absorber to generate heat from absorbed electromagnetic radiation, and from about 5 wt% to about 20 wt% flame retardant including dicyandiamide; and iteratively 230 exposing the individual polymeric build material layers with the fusing agent dispensed therewith to electromagnetic radiation to selectively fuse polymer particles of the polymeric build material in contact with the radiation absorber and to form a fused three-dimensional object.

In printing in a layer-by-layer manner, the polymeric build material can be spread, the fusing agent applied, the layer of the polymeric build material can be exposed to energy, and then a build platform can then be dropped a distance of 5 µm to 1 mm, which can correspond to the thickness of a printed layer of the three-dimensional object, so that another layer of the polymeric build material can be added again thereon to receive another application of fusing agent, and so forth. During the build, the radiation absorber in the fusing agent can act to convert the energy to thermal energy and promote the transfer of thermal heat to polymer particles of the polymeric build material in contact with the fusing agent including the radiation absorber. In an example, the fusing agent can elevate the temperature of the polymer particles of the polymeric build material above the melting or softening point of the polymer particles, thereby allowing fusing (e.g., sintering, binding, curing, etc.) of the polymeric build material (or polymer particles thereof) and the formation of an individual layer of the three-dimensional object. The method can be repeated until all the individual polymeric build material layers have been created and a three-dimensional object is formed. In some examples, the method can further include heating the polymeric build material prior to dispensing.

In one example, the method can further include, iteratively and selectively dispensing a detailing agent onto individual polymeric build material layers laterally at a border between a first area where the individual polymeric build material layer was contacted by the fusing agent and a second area where the individual polymeric build material layer was not contacted by the fusing agent. This can prevent caking around the edges due to heat from the area where the fusing agent was applied. The detailing agent can also be applied in the same area where the fusing agent was applied in order to control the temperature and prevent excessively high temperatures when the polymeric build material is fused.

In another example, the three-dimensional object formed from the method can be flame retardant in accordance with various flammability standards, such as those standards for safety and flammability of plastic materials for parts set forth by Underwriters Laboratories (UL) of the United States. Thus, in some examples, the three-dimensional object formed can prevent or slow further development of ignition of the object when ignited. This flame retardant property can be an enhancement relative to a three-dimensional object formed from the same polymeric build material and fusing agent, but which excludes the flame retardant, for example. Example flame retardancy standards can related to the tendency of the three-dimensional object to extinguish or reduce the spread of a flame once the material is ignited. In an example, the three-dimensional object can exhibit a flame retardancy rating of a UL 94 V-0 (IEC 60695-11-108). This rating indicates that burning stops within ten seconds on a vertical specimen having a thickness of about 2 mm (or more). Drips of particles are allowed as long as they are not inflamed. A specimen that is less than 2 mm thick and fails the UL94 V-0 standard but passes as a comparable 2 mm thick specimen, may obtain a UL94 V-0 rating. In another example, the three-dimensional object can exhibit a flame retardancy rating of UL 94 V-1 (IEC 60695-11-108). This rating indicates that burning stops within thirty seconds on a vertical specimen and drips of particles are allowed as long as they are not inflamed. In yet another example, the three-dimensional object can exhibit a flame retardancy rating of UL 94 V-2 (IEC 60695-11-108). This rating indicates that burning stops within thirty seconds on a vertical specimen and drips of flaming particles are allowed. To determine whether the standard for a three-dimensional object is met, the materials and processes used to generate the object can be used to prepare a standard sized object that can be from about 0.8 mm thick to about 4 mm thick. In an example, the thickness can be about 4 mm. To achieve a UL94 V-0 rating, the object should be at least 2 mm thick and meet the standards for a UL94 V-0 perimeters outlined above. The flame height of the ignition source can be 20 mm and the flame can be applied twice for ten seconds each time. The second flame can be applied as soon as the first burning ends. After applying the flame, the material can be indicated as failing the testing, or can be rated as UL 94 V-2, UL 94 V-1, or UL 94 V-0, based on the criteria set forth above. In one example, the three-dimensional object can be of a material rated as UL 94 V-2 or better, or as UL 94 V-1 or better, or UL 94 V-0 or better, for example. Though in some examples, one of the US 94 standards can be met, however, in some examples, the three-dimensional object can be a material rated under these UL 94 blue card standards. For example, the inclusion of a dicyandiamide in the fusion may increase flame resistance, but the printed object might not achieve one of these UL 94 standards, even though flame resistance has still been enhanced.

### Three-Dimensional Printing Systems

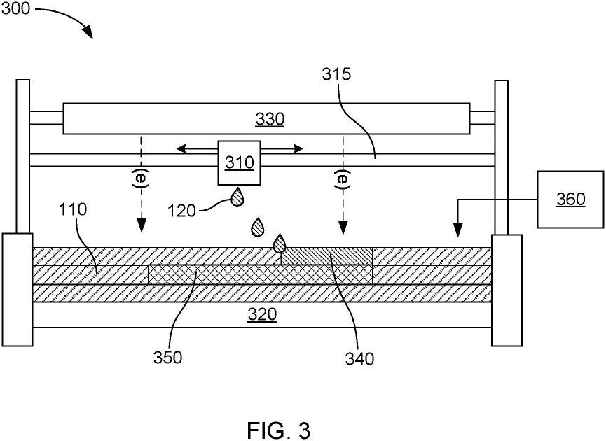

A three-dimensional printing system 300 in accordance with the present disclosure is illustrated schematically in FIG. 3. The three-dimensional printing system can include a polymeric build material 110 and a fluid applicator 310. The polymeric build material can include a polymer particles that have a D50 particle size of from about 2 µm to about 150 µm. The fluid applicator can be coupled or coupleable to a fusing agent 120. The fusing agent can include an aqueous liquid vehicle including water and an organic co-solvent, a radiation absorber to generate heat from absorbed electromagnetic radiation, and from about 5 wt% to about 20 wt% flame retardant including dicyandiamide.

In further detail, the fluid applicator 310 can be a digital fluid ejector, e.g., thermal or piezo jetting architecture. The fluid applicator, in an example, can be a fusing agent applicator that can be fluidly coupled or coupleable to the fusing agent 120 to iteratively apply the fusing agent to the polymeric build material 110 to form individually patterned object layers 340. The fluid applicator can be any type of apparatus capable of selectively dispensing or applying the fusing agent. For example, the fluid applicator can be in the form of a fluid ejector or digital fluid ejector, such as an inkjet printhead, e.g., a piezo-electric printhead, a thermal printhead, a continuous printhead, etc. The fluid applicator could likewise be a sprayer, a dropper, or other similar structure for applying the fusing agent to the polymeric build material. Thus, in some examples, the application can be by jetting or ejecting the fusing agent from a digital fluid jet applicator, similar to an inkjet pen.

In an example, the fluid applicator can be located on a carriage track 315, as shown in FIG. 3, but could be supported by any of a number of structures. In yet another example, the fluid applicator can include a motor (not shown) and can be operable to move back and forth, and the fluid applicator can also be moved front to back as well, to provide both x- and y-axis movement over the polymeric build material when positioned over or adjacent to a polymeric build material on a powder bed of a build platform.

In an example, the three-dimensional printing system can further include a build platform 320 to support the polymeric build material 110. The polymeric build material can be introduced to the build platform, or to a previously applied portion of the polymeric build material as a powder bed, from a polymeric build material supply 360. Once present on the build platform, or the powder bed, the layer of polymeric build material applied can be flattened by any of a number of techniques and/or devices suitable for establishing a thin layer of polymeric build material. The build platform can be positioned to permit application of the fusing agent from the fluid applicator onto a layer of the polymeric build material. The build platform can be configured to drop in height, thus allowing for successive layers of the polymeric build material to be applied by a supply and/or spreader. The polymeric build material can be layered in the build platform at a thickness that can range from about 5 µm to about 1 mm. In some examples, individual layers can have a relatively uniform thickness. In one example, a thickness of a layer of the polymeric build material can range from about 10 µm to about 500 µm or from about 30 µm to about 200 µm. Furthermore, heat can be applied to the build platform, or from any other direction or time, to bring the polymeric build material to a temperature near its fusing temperature, making it easier to bring up the temperature enough to generate fusion of the polymeric build material. For example, heat may be applied to the polymeric build material in the powder bed from the build platform, from above, or to the polymeric build material prior to being spread on the powder bed to preheat the polymeric build material within about 10° C. to about 70° C. of the fusing temperature of the polymer particles so that less energy may be applied to bring the polymer particles to their fusing temperature.

Following the selective application of a fusing agent to the polymeric build material, the polymeric build material can be exposed to energy (e) from an electromagnetic radiation source 330. The electromagnetic radiation source can be positioned to expose the individual layers of the polymeric build material to radiation energy to selectively fuse polymer particles of the polymeric build material in contact with the radiation absorber (forming fused layers 350) to iteratively form a three-dimensional object. The radiation source can be an infrared (IR) or near-infrared light source, such as IR or near-IR curing lamps, IR or near-IR light emitting diodes (LED), or lasers with the desirable IR or near-IR electromagnetic wavelengths, and can emit electromagnetic radiation having a wavelength ranging from about 400 nm to about 1 mm. In one example, the emitted electromagnetic radiation can have a wavelength that can range from about 400 nm to about 2 µm. In some examples, the radiation source can be operatively connected to a lamp/laser driver, an input/output temperature controller, and/or temperature sensors.

### Polymeric Build Materials

The polymeric build material can be used as the bulk material of the three-dimensional printed object. As mentioned, the polymeric build material can include from about 80 wt% to 100 wt% polymer particles. In another example, the polymeric build material can include from about 85 wt% to about 95 wt%, from about 90 wt% to 100 wt%, or 100 wt% polymer particles.

In an example, the polymeric build material can include polyamide, polyethylene, polyethylene terephthalate (PET), polystyrene, polyacrylate, polyacetal, polypropylene, polycarbonate, polyester, acrylonitrile butadiene styrene, thermoplastic polyurethane, engineering plastic, polyetheretherketone (PEEK), polymer blends thereof, amorphous polymers thereof, core-shell polymers thereof, and copolymers thereof. In another example, the polymeric build material can include a polyamide, polyethylene, polystyrene, polypropylene, polycarbonate, polymer blends thereof, amorphous polymers thereof, core-shell polymers thereof, and copolymers thereof. In a further example, the polymeric build material can include a polyamide.

The polymeric build material may include similarly sized polymer particles or differently sized polymer particles. The term "size" or "particle size," as used herein, refers to the diameter of a substantially spherical particle, or the effective diameter of a non-spherical particle, e.g., the diameter of a sphere with the same mass and density as the non-spherical particle as determined by weight. A substantially spherical particle, e.g., spherical or near-spherical, can have a sphericity of >0.84. Thus, any individual polymer particles having a sphericity of <0.84 can be considered non-spherical (irregularly shaped). For example, the polymer particles can have a D50 particle size from about 2 µm to about 150 µm, from about 25 µm to about 125 µm, from about 50 µm to about 150 µm, from about 20 µm to about 80 µm. D50 particle sizes are based on the equivalent spherical volume of the polymer particles. D50 particle sizes can be measured by laser diffraction, microscope imaging, or other suitable methodology, but in some examples, the particle size (or particle size distribution) can be measured and/or characterized using a Malvern™ Mastersizer™. This tool considers particle sizes based on diameter of the equivalent spherical volume of the polymer particles when the polymer particles are not spherical, e.g., having about a 1:1 aspect ratio.

The polymeric build material can, in some examples, further include flow additives, antioxidants, inorganic filler, or any combination thereof. Typically, an amount of any of these or other similar components can be at about 5 wt% or less. Example flow additives can include fumed silica, and/or the like. Example antioxidants can include hindered phenols, phosphites, thioethers, hindered amines, and/or the like. Example inorganic fillers can include particles such as alumina, silica, fibers, carbon nanotubes, cellulose, and/or the like. Some additives may be found in multiple categories of additives, e.g., fumed silica can be a flow additive as well as a filler. In some examples, the filler or other type of additive can become embedded or composited with the polymer particles.

The polymeric build material can be capable of being printed into three-dimensional objects with a resolution of about 10 µm to about 150 µm, about 20 µm to about 100 µm, or about 25 µm to about 80 µm. As used herein, "resolution" refers to the size of the smallest feature that can be formed on a three-dimensional object. The polymeric build material can form layers from about 10 µm to about 150 µm thick, depending on the size of polymer particles present in the polymeric build material, thus allowing the fused layers of the printed object to have about the same thickness or a few to many times (e.g., 2 to 20 times) thicker than the D50 particle size of the polymer particles, for example. This can provide a resolution in the z-axis direction (e.g., the direction of the buildup of layers) of about 10 µm to about 150 µm. In some examples, however, the polymeric build material can also have a sufficiently small particle size and sufficiently uniform particle shape to provide an x- and y-axis resolution about the size of the polymer particle size, e.g., about 2 µm to about 150 µm (e.g., the axes parallel to the support surface of the build platform).

### Fusing Agents

In further detail, regarding the fusing agent 120 that may be utilized in the three-dimensional printing kits, methods of printing a three-dimensional object, or the three-dimensional printing systems, as described herein, the fusing agent can include an aqueous liquid vehicle, a radiation absorber to generate heat from absorbed electromagnetic radiation, and from about 5 wt% to about 20 wt% flame retardant including dicyandiamide. The aqueous liquid vehicle can include water and an organic co-solvent. In one example, the aqueous liquid vehicle can include from about 25 wt% to about 90 wt% or from about 30 wt% to about 75 wt% water, and from about from about 5 wt% to about 60 wt% or from about 10 wt% to about 50 wt% organic co-solvent. In an example, the aqueous liquid vehicle can include organic-solvent to water at a ratio from about 2:1 to about 1:2, from about 1:1 to about 1:2, from about 1:1 to about 1:1.5 or from about 1:1 to about 1: 1.25.

In further detail, the fusing agent can include a radiation absorber. An amount of radiation absorber in the fusing agent can vary depending on the type of radiation absorber. In some examples, an amount of radiation absorber in the fusing agent can be from about 0.1 wt% to about 10 wt%. In another example, the amount can be from about 0.5 wt% to about 7.5 wt%. In yet another example, the amount can be from about 1 wt% to about 10 wt%. In a particular example, the amount can be from about 0.5 wt% to about 5 wt%.

Example radiation absorbers can include carbon black, a metal dithiolene complex, a near-infrared absorbing dye, a near-infrared absorbing pigment, metal nanoparticles, a conjugated polymer, or a combination thereof. In an example, the radiation absorber can be carbon black. In some examples, the radiation absorber can be colored or colorless.

Examples of near-infrared absorbing dyes can include aminium dyes, tetraaryldiamine dyes, cyanine dyes, pthalocyanine dyes, dithiolene dyes, and others. A variety of near-infrared absorbing pigments can also be used. Non-limiting examples can include phosphates having a variety of counterions such as copper, zinc, iron, magnesium, calcium, strontium, the like, and combinations thereof. Non-limiting specific examples of phosphates can include M₂P₂O₇, M₄P₂O₉, M₅P₂O₁₀, M₃(PO₄)₂, M(PO₃)₂, M₂P₄O₁₂, and combinations thereof, where M represents a counterion having an oxidation state of +2. For example, M₂P₂O₇ can include compounds such as Cu₂P₂O₇, Cu/MgP₂O₇, Cu/ZnP₂O₇, or any other suitable combination of counterions. The phosphates described herein are not limited to counterions having a +2 oxidation state. Other phosphate counterions can also be used to prepare other suitable near-infrared pigments. Additional near-infrared absorbing pigments can include silicates. Silicates can have the same or similar counterions as phosphates. One non-limiting example can include M₂SiO₄, M₂Si₂O₆, and other silicates where M is a counterion having an oxidation state of +2. For example, the silicate M₂Si₂O₆ can include Mg₂Si₂O₆, Mg/CaSi₂O₆, MgCuSi₂O₆, Cu₂Si₂O₆, Cu/ZnSi₂O₆, or other suitable combination of counterions. The silicates described herein are not limited to counterions having a +2 oxidation state. Other silicate counterions can also be used to prepare other suitable near-infrared pigments.

The flame retardant, in further detail, can be present in the fusing agent from about 5 wt% to about 20 wt%. In yet other examples, the flame retardant can be present at from about 5 wt% to about 15 wt%, from about 8 wt% to about 16 wt%, from about 8 wt% to about 12 wt%, or from about 10 wt% to about 20 wt%. The flame retardant can include dicyandiamide. Dicyandiamide has the chemical structure shown in Formula I below.

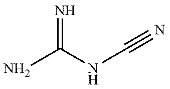

Without being limited to theory, the heteroatoms in dicyandiamide may contribute to its performance as a flame retardant. In some examples, the flame retardant can further include dicyanamide, cyanamide, melamine, guanylmelamine, polyguanylmelamine, guanidine, guanidine carbonate, guanylurea, or a combination thereof. In some examples, the flame retardant can be soluble or partially soluble in the aqueous liquid vehicle. Incorporating the flame retardant in the fusing agent can allow for voxel basis application of the flame retardant. This can permit the application of additional flame retardant at portions of the three-dimensional object formed thereof that may be more susceptible to ignition, such as thinner sections and overhangs.

In some examples, there may be other liquid or dispersed additives as well in the aqueous liquid vehicle. In some example, the aqueous liquid vehicle can further include from about 0.01 wt% to about 2 wt% or from about 0.01 wt% to about 0.5 wt% surfactant. Regarding other additives, in some examples, the fusing agent can further include a dispersant. Dispersants can help disperse the radiation absorber, the flame retardant, or a combination thereof. In some examples, the dispersant itself can also absorb radiation. Non-limiting examples of dispersants that can be included as a radiation absorber, either alone or together with a pigment, can include polyoxyethylene glycol octylphenol ethers, ethoxylated aliphatic alcohols, carboxylic esters, polyethylene glycol ester, anhydrosorbitol ester, carboxylic amide, polyoxyethylene fatty acid amide, poly (ethylene glycol) p-isooctyl-phenyl ether, sodium polyacrylate, and combinations thereof. Other additives may be present as part of the aqueous liquid vehicle, as described more fully below.

### Detailing Agents

In some examples, the three-dimensional printing kits, methods of printing a three-dimensional object, and/or three-dimensional printing systems can further include a detailing agent and/or the application thereof. A detailing agent can include a detailing compound capable of cooling the polymeric build material upon application. In some examples, the detailing agent can be printed around the edges of the portion of a polymeric build material that is or can be printed with the fusing agent. The detailing agent can increase selectivity between the fused and un-fused portions of the polymeric build material by reducing the temperature of the polymeric build material around the edge of the portion to be fused. In other examples, the detailing agent can be printed in areas where the fusing agent is printed to provide additional cooling when printing a three-dimensional object.

In some examples, the detailing agent can be a solvent that can evaporate at the temperature of the particulate build material supported on the powder bed or build platform. As mentioned above, in some cases, the polymeric build material in the powder bed can be preheated to a preheat temperature within about 10° C. to about 70° C. of the fusing temperature of the polymeric build material. Thus, the detailing agent can be a solvent that evaporates upon contact with the polymeric build material at the preheat temperature, thereby cooling the printed portion through evaporative cooling. In certain examples, the detailing agent can include water, co-solvents, or combinations thereof. In further examples, the detailing agent can be substantially devoid of radiation absorbers. That is, in some examples, the detailing agent can be substantially devoid of ingredients that absorb enough energy from the energy source to cause the polymeric build material to fuse. In certain examples, the detailing agent can include colorants such as dyes or pigments, but in small enough amounts such that the colorants do not cause the polymeric build material printed with the detailing agent to fuse when exposed to the energy source.

### Aqueous Liquid Vehicles

As used herein, the term "aqueous liquid vehicle" may refer to the liquid in the fusing agent, the detailing agent, and/or other fluid agents that may be present, e.g., coloring agent. The aqueous liquid vehicle may include water alone or in combination with a variety of additional components. With respect to the fusing agent, the aqueous liquid vehicle includes water and organic co-solvent, but with respect to the detailing agent, the aqueous liquid vehicle may be water, or may include water and organic co-solvent, for example. Examples of components that may be included, in addition to water, may include organic co-solvent, surfactant, buffer, antimicrobial agent, anti-kogation agent, chelating agent, buffer, etc. In an example, the aqueous liquid vehicle can include water and organic co-solvent. In another example, the aqueous liquid vehicle can include water, organic co-solvent, and a surfactant. In yet another example, the aqueous liquid vehicle can include water, organic co-solvent, surfactant, and buffer (or buffer and a chelating agent).

The liquid vehicle can include water that may be deionized, for example. In one example, water can be present in the fusing agent, the detailing agent, or other fluid agent at a weight percentage that can vary from about 25 wt% to about 90 wt% or from about 30 wt% to about 75 wt%.

The liquid vehicle may include organic co-solvent(s). Some examples of co-solvent that may be added to the vehicle include 1-(2-hydroxyethyl)-2-pyrollidinone, 2-pyrrolidinone, 2-methyl-1,3-propanediol, 1,5-pentanediol, triethylene glycol, tetraethylene glycol, 1,6-hexanediol, tripropylene glycol methyl ether, ethoxylated glycerol-1 (LEG-1), or a combination thereof. In one example, the co-solvent can include 2-pyrrolidonone. Whether a single co-solvent is used or a combination of co-solvents is used, the total amount of co-solvent(s) in the the fusing agent, the detailing agent, or other fluid agent can be from about 5 wt% to about 60 wt%, from about 10 wt% to about 50 wt%, from about 15 wt% to about 45 wt%, or from about 30 wt% to about 50 wt% based on a total weight percentage of the fusing agent or the total weight percentage of the detailing agent.

The aqueous liquid vehicle may also include surfactant. The surfactant can include non-ionic surfactant, cationic surfactant, and/or anionic surfactant. In one example, the fusing agent includes an anionic surfactant. In another example, the fusing agent includes a non-ionic surfactant. In still another example, the fusing agent includes a blend of both anionic and non-ionic surfactant. Example non-ionic surfactant that can be used includes self-emulsifiable, nonionic wetting agent based on acetylenic diol chemistry (e.g., SURFYNOL® SEF from Air Products and Chemicals, Inc., USA), a fluorosurfactant (e.g., CAPSTONE® fluorosurfactants from DuPont, USA), or a combination thereof. In other examples, the surfactant can be an ethoxylated low-foam wetting agent (e.g., SURFYNOL® 440, SURFYNOL® 465, or SURFYNOL® CT-111 from Air Products and Chemical Inc., USA) or an ethoxylated wetting agent and molecular defoamer (e.g., SURFYNOL® 420 from Air Products and Chemical Inc., USA). Still other surfactants can include wetting agents and molecular defoamers (e.g., SURFYNOL® 104E from Air Products and Chemical Inc., USA), alkylphenylethoxylates, solvent-free surfactant blends (e.g., SURFYNOL® CT-211 from Air Products and Chemicals, Inc., USA), water-soluble surfactant (e.g., TERGITOL® TMN-6, TERGITOL® 15S7, and TERGITOL® 15S9 from The Dow Chemical Company, USA), or a combination thereof. In other examples, the surfactant can include a non-ionic organic surfactant (e.g., TEGO® Wet 510 from Evonik Industries AG, Germany), a non-ionic a secondary alcohol ethoxylate (e.g., TERGITOLO 15-S-5, TERGITOLO 15-S-7, TERGITOLO 15-S-9, and TERGITOLO 15-S-30 all from Dow Chemical Company, USA), or a combination thereof. Example anionic surfactant can include alkyldiphenyloxide disulfonate (e.g., DOWFAX® 8390 and DOWFAX® 2A1 from The Dow Chemical Company, USA), oleth-3 phosphate surfactant (e.g., CRODAFOS™ N3 Acid from Croda, UK). Example cationic surfactant that can be used includes dodecyltrimethylammonium chloride, hexadecyldimethylammonium chloride, or a combination thereof. In some examples, the surfactant (which may be a blend of multiple surfactants) may be present in the fusing agent, the detailing agent, or other fluid agent at an amount ranging from about 0.01 wt% to about 2 wt%, from about 0.05 wt% to about 1.5 wt%, or from about 0.01 wt% to about 1 wt%.

In some examples, the liquid vehicle may also include a chelating agent, an antimicrobial agent, a buffer, or a combination thereof. While the amount of these may vary, if present, these can be present in the fusing agent, the detailing agent, or other fluid agent at an amount ranging from about 0.001 wt% to about 20 wt%, from about 0.05 wt% to about 10 wt%, or from about 0.1 wt% to about 5 wt%.

The liquid vehicle may include a chelating agent. Chelating agent(s) can be used to minimize or to eliminate the deleterious effects of heavy metal impurities. Examples of suitable chelating agents can include disodium ethylene-diaminetetraacetic acid (EDTA-Na), ethylene diamine tetra acetic acid (EDTA), and methyl-glycinediacetic acid (e.g., TRILON® M from BASF Corp., Germany). If included, whether a single chelating agent is used or a combination of chelating agents is used, the total amount of chelating agent(s) in the fusing agent, the detailing agent, or other fluid agent may range from 0.01 wt% to about 2 wt% or from about 0.01 wt% to about 0.5 wt%.

The liquid vehicle may also include antimicrobial agents. Antimicrobial agents can include biocides and fungicides. Example antimicrobial agents can include the NUOSEPT®, Ashland Inc. (USA), VANCIDE® (R.T. Vanderbilt Co., USA), ACTICIDE® B20 and ACTICIDE® M20 (Thor Chemicals, U.K.), PROXEL® GXL (Arch Chemicals, Inc.. USA), BARDAC® 2250, 2280, BARQUAT® 50-65B, and CARBOQUAT® 250-T, (Lonza Ltd. Corp., Switzerland), KORDEK® MLX (The Dow Chemical Co., USA), and combinations thereof. In an example, if included, the a total amount of antimicrobial agents in the fusing agent, the detailing agent, or other fluid agent can range from about 0.01 wt% to about 1 wt%.

In some examples, liquid vehicle may further include buffer solution(s). In some examples, the buffer solution(s) can withstand small changes (e.g., less than 1) in pH when small quantities of a water-soluble acid or a water-soluble base are added to a composition containing the buffer solution(s). The buffer solution(s) can have pH ranges from about 5 to about 9.5, or from about 7 to about 9, or from about 7.5 to about 8.5. In some examples, the buffer solution(s) can include a poly-hydroxy functional amine. In other examples, the buffer solution(s) can include potassium hydroxide, 2-[4-(2-hydroxyethyl) piperazin-1-yl] ethane sulfonic acid, 2-amino-2-(hydroxymethyl)-1,3-propanediol (TRIZMA® sold by Sigma-Aldrich, USA), 3-morpholinopropanesulfonic acid, triethanolamine, 2-[bis-(2-hydroxyethyl)-amino]-2-hydroxymethyl propane-1,3-diol (bis tris methane), N-methyl-D-glucamine, N,N,N'N'-tetrakis-(2-hydroxyethyl)-ethylenediamine and N,N,N'N'-tetrakis-(2-hydroxypropyl)-ethylenediamine, beta-alanine, betaine, or mixtures thereof. In yet other examples, the buffer solution(s) can include 2-amino-2-(hydroxymethyl)-1,3-propanediol (TRIZMA® sold by Sigma-Aldrich, USA), beta-alanine, betaine, or mixtures thereof. The buffer solution, if included, can be added in the fusing agent, the detailing agent, or other fluid agent at an amount ranging from about 0.01 wt% to about 10 wt%, from about 0.1 wt% to about 7.5 wt%, from about 0.05 wt% to about 5 wt%.

### Definitions

It is noted that, as used in this specification and the appended claims, the singular forms "a," "an," and "the" include plural referents unless the content clearly dictates otherwise.

The term "about" as used herein, when referring to a numerical value or range, allows for a degree of variability in the value or range, for example, within 10%, or, in one aspect within 5%, of a stated value or of a stated limit of a range. The term "about" when modifying a numerical range is also understood to include as one numerical subrange a range defined by the exact numerical value indicated, e.g., the range of about 1 wt% to about 5 wt% includes 1 wt% to 5 wt% as an explicitly supported sub-range.

As used herein, "kit" can be synonymous with and understood to include a plurality of multiple components where the different components can be separately contained (though in some instances co-packaged in separate containers) prior to use, but these components can be combined together during use, such as during the three-dimensional object build processes described herein. The containers can be any type of a vessel, box, or receptacle made of any material.

As used herein, "dispensing" when referring to fusing agents that may be used, for example, refers to any technology that can be used to put or place the fluid, e.g., fusing agent, on the polymeric build material or into a layer of polymeric build material for forming a green body object. For example, "applying" may refer to "jetting," "ejecting," "dropping," "spraying," or the like.

As used herein, "jetting" or "ejecting" refers to fluid agents or other compositions that are expelled from ejection or jetting architecture, such as ink-jet architecture. Ink-jet architecture can include thermal or piezoelectric architecture. Additionally, such architecture can be configured to print varying drop sizes such as up to about 20 picoliters, up to about 30 picoliters, or up to about 50 picoliters, etc. Example ranges may include from about 2 picoliters to about 50 picoliters, or from about 3 picoliters to about 12 picoliters.

As used herein, a plurality of items, structural elements, compositional elements, and/or materials may be presented in a common list for convenience. However, these lists should be construed as though the individual member of the list is identified as a separate and unique member. Thus, no individual member of such list should be construed as a de facto equivalent of any other member of the same list based on presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, as well as to include all the individual numerical values or sub-ranges encompassed within that range as the individual numerical value and/or sub-range is explicitly recited. For example, a weight ratio range of about 1 wt% to about 20 wt% should be interpreted to include the explicitly recited limits of 1 wt% and 20 wt% and to include individual weights such as about 2 wt%, about 11 wt%, about 14 wt%, and sub-ranges such as about 10 wt% to about 20 wt%, about 5 wt% to about 15 wt%, etc.

### EXAMPLES

The following illustrates examples of the present disclosure. Numerous modifications and alternative compositions, methods, and systems may be devised without departing from the present disclosure. The appended claims are intended to cover such modifications and arrangements.

### Example 1 - Preparation of a Fusing Agents

Two fusing agent formulations were prepared by admixing the components in Tables 1 and 2 below. Table 1 is an example fusing agent prepared in accordance with the present disclosure, and Table 2 represents a "Control" fusing agent without a flame retardant compound.

Table 1

Fusing Agent with Flame Retardant

| Component | Amount (wt%) |
|---|---|
| Deionized Water | 43.94 |
| 2-Pyrrolidone (Organic Co-solvent) | 40 |
| Carbon Black (Radiation Absorber) | 5 |
| Dicyandiamide (Flame Retardant) | 10 |
| Surfactant Blend | 0.93 |
| Buffer | 0.10 |
| Chelator | 0.04 |

Table 2

Control Fusing Agent

| Component | Amount (wt%) |
|---|---|
| Deionized Water | 66.4 |
| 2-Pyrrolidone (Organic Co-solvent) | 19 |
| Triethylene Glycol | 8 |
| Carbon Black (Radiation Absorber) | 5 |
| Surfactant Blend | 1.2 |
| Chelator | 0.04 |
| Biocide | 0.32 |

### Example 2 - Preparation of Three-Dimensional Objects

Four three-dimensional printed objects were prepared in the shape of dog bones (or barbells) using a polymeric build material having Nylon-12 (PA-12) particles. The fusing agents used with these polymeric build material were the fusing agents prepared in accordance with Table 1 (with Flame Retardant) and Table 2 (Control without Flame Retardant) using a common set of printing conditions, e.g., fuse speeds of 22 inches per second per pass and from about 64 to about 70 contone of the fusing agent. The powder bed was set to a temperature of 165° C. The dog bone objects were formed with an elongated middle section flanked by two end sections. The three-dimensional printed objects were printed using multi-jet fusion (MJF) printers with the fusing agent from Table 1 or Table 2, which were iteratively jetted layer-by-layer on the PA-12 polymer particles of the polymeric build material. An identical electromagnetic energy source was used to selectively form the dog bone objects which included multiple fused layers.

### Example 3 - Flammability

The various dog bone samples prepared in accordance with Example 2 were evaluated for flammability in duplicate (two with example fusing agent of Table 1 and two with Control fusing agent of Example 2). The testing was performed accordance with a protocol similar to the UL 94 blue card standards, other than with respect object dimension parameters, to see if there was an enhancement in flame retardant properties. The samples were subjected to a 20 mm high flame for 10 seconds, removed from the flame, and the time for extinguishment to occur recorded. Once extinguished, the part was immediately subjected to a 20 mm high flame for 10 additional seconds and then removed from the flame, and then a second time for extinguishment to occur was recorded. The results are shown in Table 3 below.

Table 3

Flammability Test Results

| Sample | Fusing Agent | 1^{st} Extinguish Time (seconds) | 2^{nd} Extinguish Time (seconds) | Pass/Fail |
|---|---|---|---|---|
| A | Control (Table 2) | >10 | n/a - did not pass second burn | Fail |
| B | Control (Table 2) | >10 | n/a - did not pass second burn | Fail |
| C | w/ Flame Retardant (Table 1) | <1 | <30 | Pass |
| D | w/ Flame Retardant (Table 1) | <1 | <30 | Pass |

As can be seen above, samples A and B did not pass the second flame event, as these sample were completely engulfed. Samples C and D printed with the fusing agent that included the flame retardant extinguished in less than 30 seconds.

What is claimed is:

1. A three-dimensional printing kit comprising:
a polymeric build material including polymer particles having a D50 particle size from about 2 µm to about 150 µm; and
a fusing agent comprising an aqueous liquid vehicle including water and an organic co-solvent, a radiation absorber to generate heat from absorbed electromagnetic radiation, and from about 5 wt% to about 20 wt% flame retardant including dicyandiamide.

2. The three-dimensional printing kit of claim 1, wherein the flame retardant further includes dicyanamide, cyanamide, melamine, guanylmelamine, polyguanylmelamine, guanidine, guanidine carbonate, guanylurea, or a combination thereof.

3. The three-dimensional printing kit of claim 1 wherein the flame retardant is present in the fusing agent at from about 8 wt% to about 16 wt%.

4. The three-dimensional printing kit of claim 1, wherein the radiation absorber includes carbon black, a metal dithiolene complex, a near-infrared absorbing dye, a near-infrared absorbing pigment, metal nanoparticles, a conjugated polymer, or a combination thereof.

5. The three-dimensional printing kit of claim 1, wherein the radiation absorber is present in the fusing agent at from about 0.1 wt% to about 10 wt%.

6. The three-dimensional printing kit of claim 1, wherein the aqueous liquid vehicle further includes from about 0.01 wt% to about 2 wt% surfactant.

7. The three-dimensional printing kit of claim 1, wherein the polymeric build material includes polyamide, polyethylene, polyethylene terephthalate (PET), polystyrene, polyacrylate, polyacetal, polypropylene, polycarbonate, polyester, acrylonitrile butadiene styrene, thermoplastic polyurethane, engineering plastic, polyetheretherketone (PEEK), polymer blends thereof, amorphous polymers thereof, core-shell polymers thereof, and copolymers thereof.

8. The three-dimensional printing kit of claim 1, further comprising a detailing agent, wherein the detailing agent includes a detailing compound to reduce a temperature of the polymeric build material onto which the detailing agent is applied.

9. A method of printing a three-dimensional object comprising:
iteratively applying individual polymeric build material layers of a polymeric build material including polymer particles having a D50 particle size from about 2 µm to about 150 µm;
based on a 3D object model, iteratively and selectively dispensing a fusing agent onto individual polymeric build material layers, wherein the fusing agent comprises an aqueous liquid vehicle including water and an organic co-solvent, a radiation absorber to generate heat from absorbed electromagnetic radiation, and from about 5 wt% to about 20 wt% flame retardant including dicyandiamide; and
iteratively exposing the individual polymeric build material layers with the fusing agent dispensed therewith to electromagnetic radiation to selectively fuse polymer particles of the polymeric build material in contact with the radiation absorber and to form a fused three-dimensional object.

10. The method of claim 9, wherein the flame retardant further includes dicyanamide, cyanamide, melamine, guanylmelamine, a polyguanylmelamine, guanidine, guanidine carbonate, guanylurea, or a combination thereof.

11. The method of claim 9, w wherein the radiation absorber includes carbon black, a metal dithiolene complex, a near-infrared absorbing dye, a near-infrared absorbing pigment, metal nanoparticles, a conjugated polymer, or a combination thereof.

12. The method of claim 9, wherein the flame retardant is applied to the individual polymeric build material layers at a flame retardant to polymeric build material weight ratio from about 1:20 to about 1:100.

13. The method of claim 9, further comprising iteratively and selectively dispensing a detailing agent onto individual polymeric build material layers laterally at a border between a first area where the individual polymeric build material layer is contacted by the fusing agent and a second area where the individual polymeric build material layer is not contacted by the fusing agent.

14. A three-dimensional printing system comprising:
a polymeric build material including polymer particles having a D50 particle size from about 2 µm to about 150 µm; and
a fluid applicator fluidly coupled or coupleable to a fusing agent, wherein the fluid applicator is directable to iteratively apply the fusing agent to layers of the polymeric build material, the fusing agent comprising an aqueous liquid vehicle including water and an organic co-solvent, a radiation absorber to generate heat from absorbed electromagnetic radiation, and from about 5 wt% to about 20 wt% flame retardant including dicyandiamide.

15. The three-dimensional printing system of claim 14, further comprising an electromagnetic radiation source positioned to provide electromagnetic radiation to the layers of the polymeric build material having the fusing agent applied thereto.
